(19) United States
(12) Patent Application Publication
(10) Pub. No.: US 2026/0072527 A1
(43) Pub. Date: Mar. 12, 2026

(54) MULTI-CONFIGURATION, REDUNDANT, FIXED-AXIS JOYSTICK

(71) Applicant: Woodward, Inc., Fort Collins, CO (US)

(72) Inventors: Jeffery T. Voiles, Fort Collins, CO (US); Roy Romana, Fort Collins, CO (US); Gabriel T. Bayse, Fort Collins, CO (US); Thomas H. Block, Fort Collins, CO (US)

(21) Appl. No.: 19/319,093

(22) Filed: Sep. 4, 2025

Related U.S. Application Data
(60) Provisional application No. 63/691,939, filed on Sep. 6, 2024.

(51) Int. Cl. G06F 3/0338

(52) U.S. Cl. CPC G06F 3/0338; G06F 2203/015

(57) ABSTRACT

Methods and systems for a control device, defined as a multi-configuration, redundant, fixed-axis control device. Disclosed systems include one or more members configured to translate about one or more corresponding axes; and a mount in a fixed plane and configured to support one or more gimbals, each gimbal connected to a corresponding member and configured to translate in a corresponding axis.

### PRIORITY CLAIM/INCORPORATION BY REFERENCE

This application is a Non-Provisional Patent Application claiming priority to U.S. Provisional Patent Application No. 63/691,939 entitled “Multi-Configuration, Redundant, Fixed-Axis Joystick” filed Sep. 6, 2024, which is herein incorporated by reference in its entirety.

### FIELD

Certain embodiments of the disclosure relate to a multi-configuration, redundant, fixed-axis control device. More specifically, certain embodiments of the disclosure relate to a control device that includes one or more members configured to translate about one or more corresponding axes; and a mount in a fixed plane and configured to support one or more gimbals, each gimbal connected to a corresponding member and configured to translate in a corresponding axis.

### BACKGROUND

Designing systems with redundancies are common in the aerospace industry, due to the desire for auxiliary controls to support a primary control. This is different from many engineering disciplines, which teach reduction of redundancies to minimize unnecessary material and/or reduce complexity. By contrast, the harsh environments in which many aircraft operate, coupled with the expectation for years, often decades, of use, aerospace engineers are taught to incorporate redundancies in their projects. A control system that provides reliable, redundant control outputs for a variety of applications is therefore desirable.

Further limitations and disadvantages of conventional and traditional approaches will become apparent to one of skill in the art, through comparison of such systems with the present disclosure as set forth in the remainder of the present application with reference to the drawings.

### BRIEF SUMMARY

A system and/or method is provided for a control device that includes one or more members configured to translate about one or more corresponding axes; and a mount in a fixed plane and configured to support one or more gimbals, each gimbal connected to a corresponding member and configured to translate in a corresponding axis.

These and various other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 provides a perspective view of a fixed-axis joystick gimbal, in accordance with an example embodiment of the disclosure.

FIG. 2 is a perspective view of an active side stick configuration employing the joystick shown in FIG. 1, in accordance with an example embodiment of the disclosure.

FIGS. 3A and 3B illustrate various joystick mounting options, in accordance with an example embodiment of the disclosure.

FIGS. 4A to 4D illustrate an example active, semi-active, and passive joystick configurations, in accordance with an example embodiment of the disclosure.

FIG. 5 illustrates a single axis multifunction lever, in accordance with an example embodiment of the disclosure.

The figures are not necessarily to scale. Where appropriate, similar or identical reference numbers are used to refer to similar or identical components.

### DETAILED DESCRIPTION

As utilized herein, “and/or” means any one or more of the items in the list joined by “and/or”. For example, “x and/or y” means any element of the three-element set {(x), (y), (x, y)}. Similarly, “x, y, and/or z” means any element of the seven-element set {(x), (y), (z), (x, y), (x, z), (y, z), (x, y, z)}. As utilized herein, the term “module” refers to functions that can be implemented in hardware, software, firmware, or any combination of one or more thereof. As utilized herein, the term “exemplary” means serving as a non-limiting example, instance, or illustration.

Disclosed control systems include a single point of control (e.g., a manually operable stick) employing a gimbal operable to translate in one or more axes. In some examples, the control system has a fixed axis and a redundant loadpath.

Disclosed is a control system that includes one or more fixed-axis gimbals, while not sacrificing any control outputs or redundancy. For instance, in the event of a support pin failure (on one of the gimbals), a redundant load path would allow a stick of the control system to continue operating, thereby ensuring continued, reliable operation of the vehicle (e.g., aircraft). Advantageously, the gimbal design employed is less complex than conventional designs. This is achieved by utilizing smaller and less complex parts. The elegant design further reduces the number and cost of needed components, further reducing risk.

The disclosed control system is configurable, such that the stick and gimbal device can be made as either a passive or active control stick (e.g., manual control joystick). For example, the passive control stick can be balanced by counterweights, while an active control stick can employ sensors and/or motors to center the control stick.

Moreover, the control system can be produced at a smaller size than conventional controls. As illustrated in the several figures, the joystick, gimbals, and translating members are defined by a vertically stacked form factor. This serves to keep the envelope as small as possible, all of which makes it more easily attachable to a variety of aircraft, with a substantial degree of mounting flexibility. Moreover, the vertical symmetry (e.g., about one or more axis) allows for the control system to be flipped, while maintaining its functionality.

This process further serves to reduce the number of parts to be manufactured and reduces the time needed to train members to assemble the products, due to overlap between passive and active versions.

Although several disclosed embodiments describe control systems operable in multiple axes, the disclosed design is configurable to operate as a single axis lever.

Some example control systems are configured to provide control in two axes, while the design has the flexibility of allowing a third axis of motion. In this manner, the control system can control pitch, roll, and/or yaw in a single stick.

Due to the size and operability of disclosed control system, the configurable system has the capability to stack up to four levers in a throttle quadrant assembly (TQA). Further, two or more control systems can be linked together, such as to link pilot and copilot stations. As the functionality of the disclosed control system is similar to or greater than a conventional system, the disclosed control system can be used as a replacement or substitute for conventional systems.

Commonality between one, two, and three axis inceptors advantageously provides configurable systems, which can be modified for a specific inceptor application.

The disclosed system provides an efficient loadpath between interface and output. This feature allows for the system to maintain a small and effective envelope, and yields additional cost advantages.

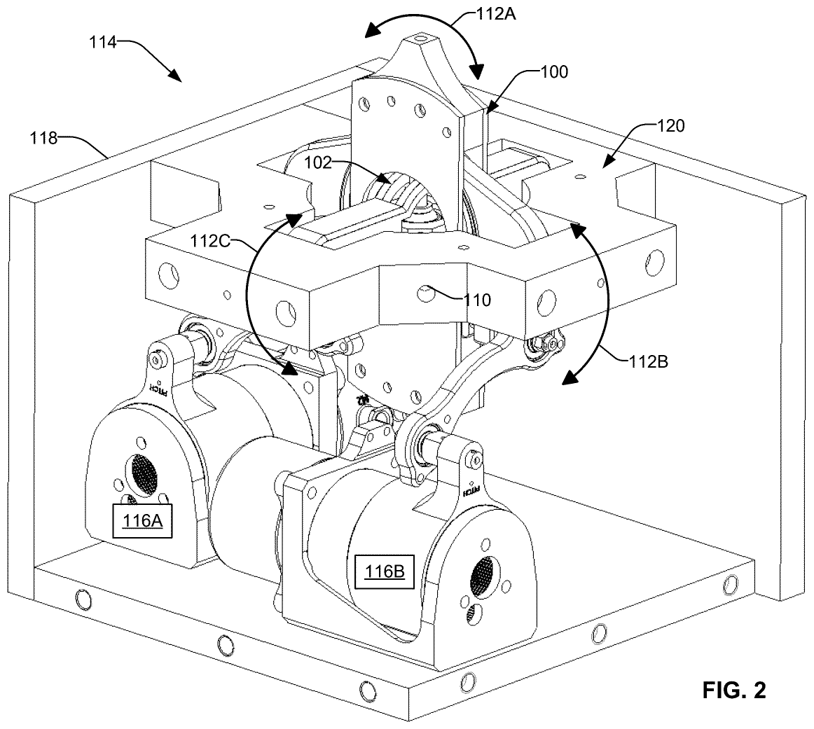

Multipiece plate chassis construction is also an option when called for in certain applications. For example, the mount 120 (e.g., chassis) could have a multipiece construction (e.g., for cost or manufacturing considerations), similar to the view depicted in FIG. 2 items 120 and 118, as well as other plates to transfer load to one or more mounting points.

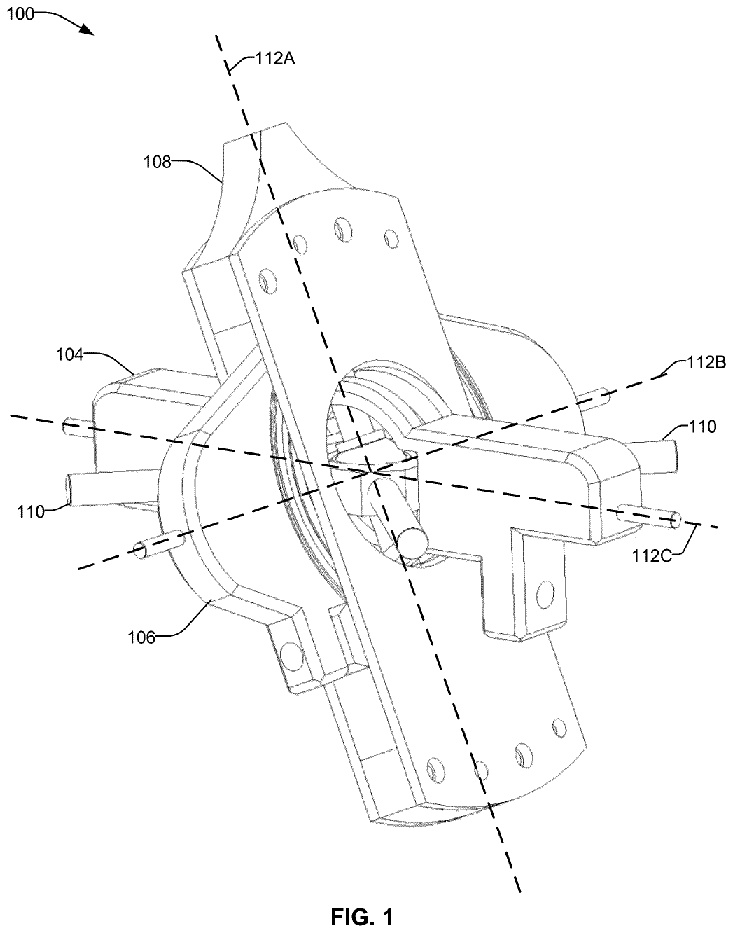

FIG. 1 provides perspective views of a fixed-axis joystick gimbal, in accordance with an example embodiment of the disclosure. FIG. 1 illustrates a perspective view of an example joystick 100 implementing a redundant fixed axis concept. The joystick 100 employs one or more gimbles 102 in the center of the device, providing movement in three axes. As shown, a vertical member 108 aligned with a first, Y-axis 112A, a first horizontal member 106 aligned with a second, X-axis 112B, and a second horizontal member 104 aligned with a third, Z-axis 112C. As shown, each member is at an angle normal relative to each other member.

FIG. 1 provides a perspective view of the example joystick 100, with one or more members oriented at a non-normal angle relative to at least one other member. This design is capable of activating redundant loadpaths while maintaining a fixed axis of motion for one axis. For instance, the first horizontal member 106 (along the designated X-axis) could be configured to control either pitch or roll in a side stick/joystick gimbals 102. In some examples, the second horizontal member (along the designated Z-axis 112C) could be configured to control either pitch or roll in a side stick/joystick gimbals 102. As shown, both gimbals 102 are supported with pins and/or bearings 110.

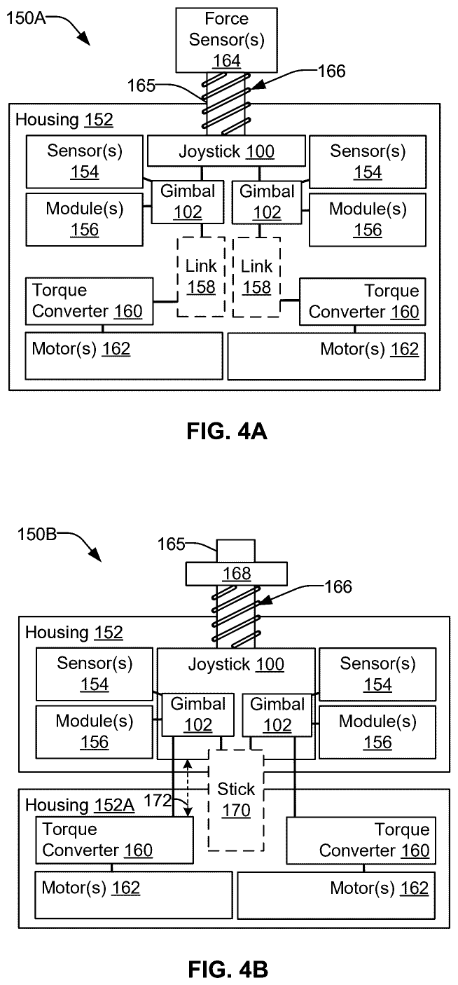

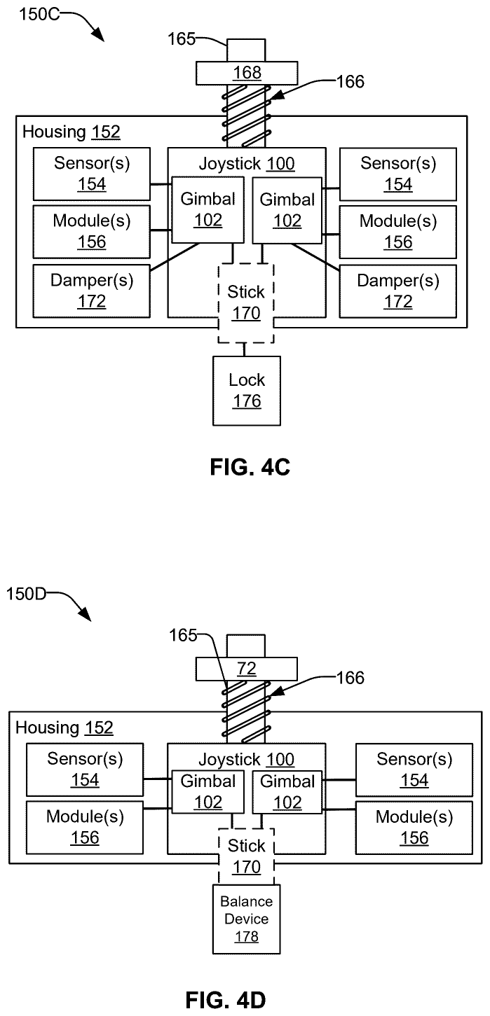

As shown, the redundant loadpath is offset 90 degrees of the primary loadpath and supports a central hub (supported by pins 110) and spherical bearing (of the gimbal) for the redundant load support. In the event of a failure in one of the connector pins along the primary loadpath, the joystick 100 operates as the redundant loadpath, thereby absorbing the force and keeping the stick (e.g., stick 165 of FIGS. 4A to 4D) in-place and functional.

The purpose of the fixed pins/architecture with a redundant load path is provided in a multi-axis joystick configuration, which may operate on two axes, but can be reconfigured for applications operating in one, two or three axes'inceptors.

FIG. 2 is a perspective view of an active side stick configuration 114 employing the joystick 100 shown in FIG. 1, in accordance with an example embodiment of the disclosure. FIG. 2 provides the joystick 100 incorporated within a housing 118, and supported by a mount 120. By holding pins 110 within the mount 120, a two-axis configuration can readily be reworked into a three-axis configuration, with the central housing on a bearing to transmit a yaw reading (e.g., a cylindrical housing in which the side stick can reside, and may anchor the side stick via the pins 110). In some examples, the cylindrical housing can itself move (in/out translation) or rotate (e.g., in response to operator inputs).

As provided in FIG. 2, one or more motors 116A and 116B are connected to pitch and roll gimbals, allowing them to backdrive the joystick 100, thereby offering the functionality of an active stick. This design will have the capability to be produced into either an active or passive version of a side stick, with FIG. FIG. 2 illustrating a perspective view of an active configuration.

Since one or more connectors are configured to screw into the gimbals, a passive version of the stick can use the same gimbal system 102 (as shown in embodiments of FIGS. 4C and 4D). Some examples would employ a separate lockout device or technique, which could use a common device configuration for both active and passive controls, thereby creating a configurable architecture.

Advantageously, the disclosed multi-configuration device provides the option of including functionality to control a third axis of motion. For instance, the joystick 100 could become a sidestick that controls pitch, roll, and yaw simultaneously (e.g., in an aerial vehicle), and/or in other applications where three axes control is beneficial.

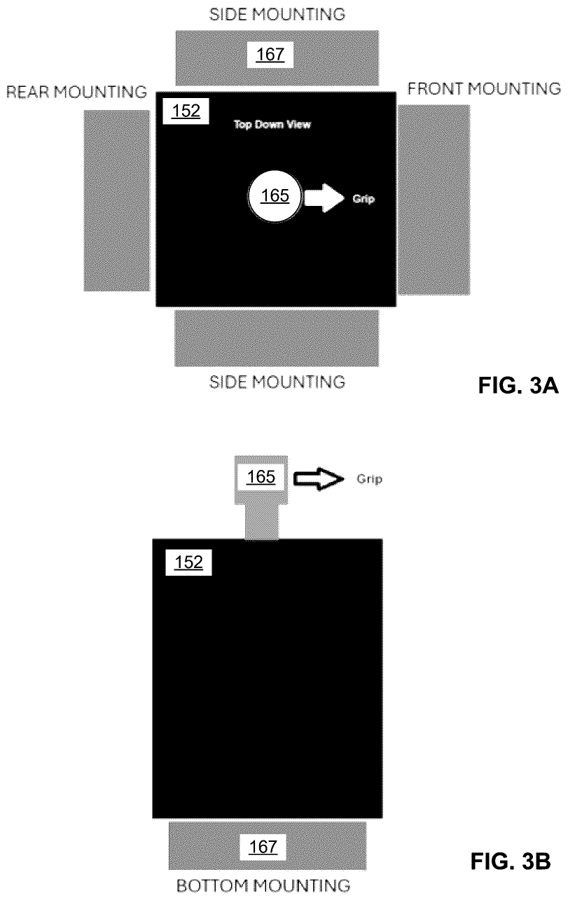

FIGS. 3A and 3B illustrate joystick mounting options, in accordance with an example embodiment of the disclosure. For instance, different types of vehicles (e.g., aerial vehicle) may benefit from employing controls mounted in different locations relative to the operator and/or other controls. For example, a helicopter typically mounts a sidestick from the base, whereas a commercial fixed winged jet mounts such a sidestick from a top plate for a passive stick, or the top plate and a second side plate of an active stick. The disclosed devices are configurable for different mounting options to accommodate a variety of control requirements.

For example, FIG. 3A shows a top-down view of a sidestick 165 mounted within a housing 152, with electronics and/or inceptor boxes 167 mounted on any side of the housing 152 and/or sidestick 165. The configuration illustrated in FIG. 3B shows the electronics box and/or inceptor unit 167 mounted below the housing 152 and/or sidestick 165. Although illustrated as either side or bottom mounted, one or more units 167 may be mounted on two or more sides and/or the bottom.

FIGS. 4A to 4D illustrate an example active, semi-active, and passive joystick configurations, in accordance with an example embodiment of the disclosure.

The disclosed systems provide flexibility to add, remove, and/or modify one or more components to tailor the device for a desired application. In the illustrated examples, one or more linkages (e.g., physical and/or functional) are illustrated as lines between components (e.g., links from the joystick 100 to the gimbals 102, and then to sensors 154, modules 156, and/or links 158). As provided in the following figures, various embodiments representing active and/or semi active arrangements (e.g., FIGS. 4A and 4B) could employ the disclosed joystick 100. As shown in FIG. 4A, a control system 150A includes the joystick 100 (with the gimbals 102) arranged within a housing 152. The joystick 100 is configured to operate as a dual-axis cam plunger, which receives physical commands from a stick 165 and force feedback via force sensor 164. A spring 166 biases the force sensor 165 in a vertical direction.

In some examples, the stick 165 can additionally or alternatively translate upwards and/or downwards relative to the housing 152 to provide additional commands. The stick 165 can additionally or alternatively rotate about a central axis to provide additional commands.

One or more sensors 154 can be connected to the members 104, 106, 108, to gauge movement of the joystick 100. Measurements from the sensors 154 can be transmitted to a controller, which can determine movement of the stick 165 and thus a commanded movement of the vehicle in which the system 150A operates.

One or more modules 156 are located within the housing 152, operable to provide forces designed to center and/or provide soft stop for the joystick 100 and/or stick 165 in one or more of the operating axes.

A transfer link 158 connects the joystick 100 and/or one or more members of the joystick 100 to corresponding torque converters 160. The torque converters 160 measure and/or respond to forces applied by movement of the joystick 100/stick 165 and translate the forces to motors 162, which activate one or more vehicle components (not shown) to control movement thereof.

In some examples, the system 150A is semi-active, configured for operation without the use of a force sensor while employing the other components of an active device.

The system 150B illustrated in FIG. 4B is capable of balancing forces acting on the joystick 100/stick 165 by using functional mass to implement an active or semi active arrangement. For example, the housing 152A may be separated from housing 152, configured to rotate with a turn of the stick 165. A post, gear, belt and/or other linkage 172 can be employed to connect the joystick 100 with the components within housing 152A. For example, the linkage is configured to transfer power and/or motion from a motor to a corresponding gimbal, subsequent to the sensors and joystick. As shown, a bearing 168 is employed in place of a force sensor. However, in some examples, a force sensor can be incorporated in the design illustrated in FIG. 4B.

As illustrated in FIG. 4C, system 150C is configured to operate as an unbalanced, passive sidestick suitable for low complexity and/or small envelope applications (e.g., smaller vehicles, such as electric vertical takeoff and landing (EVTOL) vehicles). In the example of FIG. 4C, one or more dampers 172 are included for each axis, to provide passive, yet unbalanced, control. Further, a stick 170 extends from the joystick 100 and connects to an autopilot lock 176. For example, the autopilot lock 176 provides an additional detent lock and/or breakout force for the side stick at a null position. This can be in addition to a default detent/lock employed during autopilot mode of passive stick type. The lock provides to the pilot a tactile indication that the autopilot system is engaged.

FIG. 4D provides an example system 150D configured to operate as a balanced, passive sidestick. As shown, the system 150D employs a balance device 178 attached to the stick 170. The balance device 178 may be a damper for one or more of the axes, and may be part of a mass balance device 178, but is not so required. The device 178 may also be and/or include an autopilot lock (similar to the system 150C). Additionally or alternatively, the device 178 may employ a three dimensional cam plunger, which may be part of a mass balance device 178, but is not so required. Such a design may be suitable for a variety of vehicles, including dynamic military vehicles and/or rotorcraft.

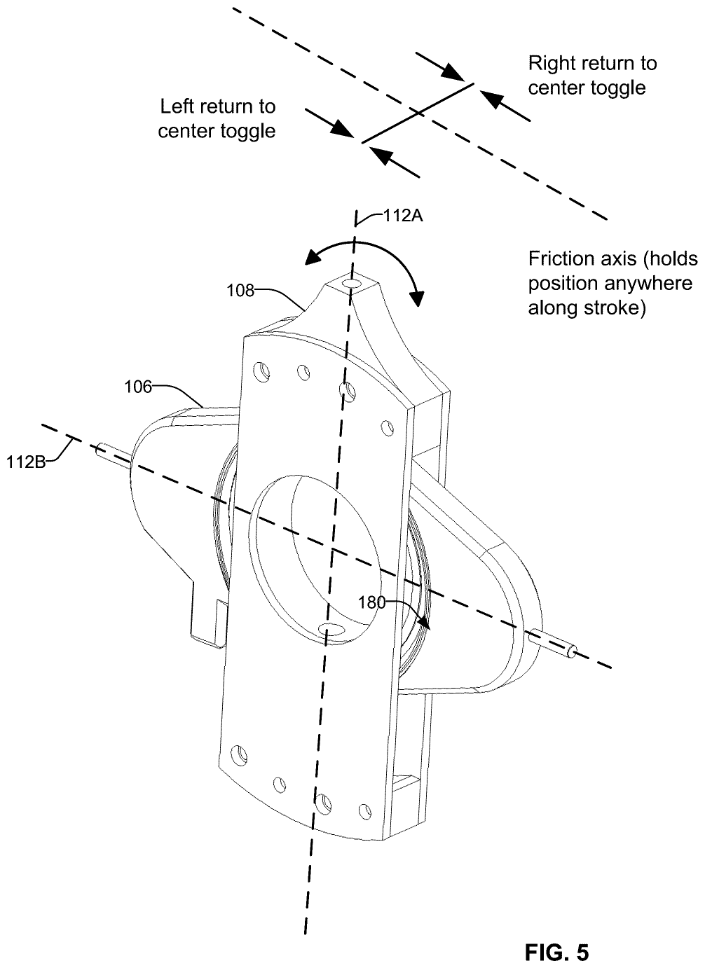

FIG. 5 illustrates a single axis multifunction lever, in accordance with an example embodiment of the disclosure. As shown, the member 108 is configured to translate/rotate in the plane defined by the 112A and 112B axes. The member 108 can be joined to the member 106 such that arcuate movement of member 108 is implemented about a circular mount 180, which may include a bearing, ring, coil, and/or spring. The mount 180 may serve to limit the extent of movement from the axis 112A centerline, and/or modify friction as the member 108 moves.

For example, the mount 180 may present a surface which provides physical friction at the interface between member 108 and the mount 180. In some examples, the frictional force is designed to be greater at some portion of the mount 180, corresponding to positions along the plane. For instance, the member 108 may experience little resistance at a first threshold angle from the centerline (e.g., 10-30 degrees), yet the resistance may increase beyond a second threshold (e.g., beyond 30 degrees).

In some examples, biasing and/or limiting the range of movement of member 108 can be achieved by use of springs, coils or other biasing devices. As provided in FIG. 5, the biasing member (not shown) may force the member 108 to return to a desired position relative to the member 106 (e.g., the center of toggle, i.e. at axis 112A). Further, physical stops (e.g., detents, etc.) can be incorporated to limit movement beyond a desired threshold beyond the centerline in one or more directions (e.g., fore and/or aft).

An advantageous aspect of such a single axis design of the redundant load path concept is for a single axis, multi-lever inceptor (e.g. a dual engine throttle lever). When incorporated with a single handle, a side action of the lever can be biased to a return to a center detent, however two or more detents can be arranged along the movement path for the member 108. This could allow for trimming or skewing of the left/right controls independently for fine adjustment.

In disclosed examples, the joystick is applicable in a sidestick application to sense pilot commands corresponding to a desired yaw, angle of pitch and/or roll axes of an aircraft. For example, in an aircraft cockpit environment, a sidestick or sidestick controller is an aircraft control column (or joystick) that is located on the side console of the pilot. For instance, only one hand is required to operate the sidestick, which makes it a simple and intuitive tool to control yaw, pitch and/or roll of an aircraft. Although examples are provided with respect to a sidestick application, aircraft controls mounted in control columns may be arranged in a center of the cockpit. Moreover, applications beyond aerospace, and beyond control mechanisms, are considered as well.

Further, although examples are provided with respect to applications in a flight deck (e.g., a sidestick application), the technology and platform may be useful in a variety of applications in aerospace, manufacturing, automotive, electronic sports, virtual gaming, or transportation, to list but a few. In examples, the disclosed control technology can be employed in joystick applications, such as large industrial equipment (e.g., construction, agriculture, etc.), gaming, or other applications that employ a single, physical control interface for multiple axis control.

Advantageously, the control system employs redundant channels, designed to meet or exceed regulatory guidelines for redundancy in a sidestick application.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A multi-configuration, redundant, fixed-axis control device comprising:
one or more members configured to translate about one or more corresponding axes; and
a mount in a fixed plane and configured to support one or more gimbals, each gimbal connected to a corresponding member and configured to translate in a corresponding axis.

2. The device of claim 1, further comprising a joystick connected to a member of the one or more members.

3. The device of claim 2, further comprising a housing to support the one or more gimbals and the joystick.

4. The device of claim 3, wherein the joystick is configured to translate up and down relative to the housing.

5. The device of claim 4, wherein the mount is supported within the housing by one or more pins.

6. The device of claim 1, wherein the control device is a sidestick.

7. The device of claim 1, wherein the sidestick is mounted on a side, rear, front or bottom of a control panel.

8. The device of claim 1, wherein further comprising one or more weights to provide passive feedback.

9. The device of claim 1, further comprising one or more motors to provide active feedback.

10. The device of claim 9, further comprising one or more torque converters to translate force to the one or more motors.

11. The device of claim 1, wherein the one or more members are configured to provide movement in three axes of movement.
